(19) United States
(12) Patent Application Publication
(10) Pub. No.: US 2022/0266215 A1
(43) Pub. Date: Aug. 25, 2022

(54) Optimised Composition for Reducing Water Evaporation and Preventing and/or Delaying the Growth of Microalgae

(71) Applicant: 02 BET MEM VAV SPA, Santiago (CL)

(72) Inventors: Carlos Enrique Körner Fuenzalida, Santiago (CL); Javiera Natalia Quintana Rodríguez, Santiago (CL)

(73) Assignee: 02 BET MEM VAV SPA, Santiago (CL)

(21) Appl. No.: 17/625,533

(22) PCT Filed: Oct. 23, 2020
(86) PCT No.: PCT/CL2020/050141

§ 371 Date: Jan. 7, 2022

(30) Foreign Application Priority Data
Oct. 24, 2019 (CL) 3062-2019

(51) Int. Cl. B01J 19/16; C02F 1/68

(52) U.S. Cl. CPC B01J 19/16; C02F 1/68; C02F 2103/02

(57) ABSTRACT

The present invention relates to an optimised composition for reducing water evaporation and for preventing and/or N delaying the growth of microalgae, which is an organic microlayer comprising one or more hydrophobic-chain amphiphilic molecules and a biodegradable volatile organic solvent. In addition, the invention relates to a method for reducing water evaporation and for preventing and/or delaying the growth of microalgae, by applying said composition to aqueous surfaces.

### BACKGROUND AND STATE OF THE ART

Water is one of the most fundamental natural resources present, both in daily life and at the industrial level, given its usefulness and high availability. It is used by all branches of life as a solvent for important biological reactions and temperature maintenance, as well as in industry, where it is similarly used as a washing solvent, heat exchange, chemical reaction medium, among others. Because it is used in large quantities, water is commonly found in the open air, in large reservoirs and then stored and used directly. These reservoirs are prone to water loss through direct evaporation by exposure to the sun, high temperatures and winds, and are commonly found in dams, agricultural crops and mining sites. In the case of the mining industry, it is mainly used as a medium for the electrorefining of metals (mainly copper), drilling and washing of minerals in the deposits for the flotation process. In the case of its use as a source of potable water for agricultural or human consumption, it is stored in large reservoirs exposed to the air to maintain a large volume of treated water in case of emergency or immediate need.

In Chile, the mining industries use these reservoirs in the extraction and production of metals, and in the places where they are located there is generally no direct access to a water source, as is the case of the mines in the central-northern zone of Chile such as Los Bronces, Ministro Hales, Caserones, among others, so water must be transported to the reservoirs. Water evaporates an average of 5.5 mm per day, which is equivalent to 55 m³ of water per hectare per day [1], so its loss due to evaporation implies a high cost for the mining companies simply for transporting it to these reservoirs to replenish its level. An estimate made by Cochilco for the year 2026 indicates that, at the current rhythm, the mining industry will demand approximately 21.5 m³ of seawater per second, with 50% of this water being desalinated, considering a cost of desalination and seawater transport of approx. 5.1 USD/m³ according to the Department of Studies, Extension and Publications in 2017. Therefore, the daily evaporated amount at the national level is a considerable cost and there are economic incentives to solve this situation.

Currently, various methods are used to prevent water loss in reservoirs, such as covering them with a dark plastic foil, the use of floating plastic spheres known as shade balls, among others. However, these have proven ineffective as the amount of surface to be covered is immense, reaching up to 200 hectares in some cases, the water surface is mobile and difficult to cover without leaving free spaces for evaporation, and strong winds tend to undo the covering structure. In addition, shade balls, although they have an effect of reducing water evaporation, the production of the plastic used is a negative externality since more water is consumed in the production of the spheres than the amount saved in the reservoir where it is applied. For example, according to Science Alert, California used these spheres and saved 1.7 million m³ of water in potable water reservoirs, but the water consumption in the production of the 96 million spheres corresponded to approx. 2.9 million m³ of water [2]. In addition, the effect of plastic degradation must be considered, producing microplastics that can be toxic to other living beings and harmful to machinery that uses water from the reservoir.

In the current state of the art, there are several proposals regarding the prevention of water evaporation. There is a patent that uses a physical barrier to water evaporation through the use of a set of polyhedral called pentagonal dodecahedra, which are perfectly coupled and float on the surface of the water, forming a protective layer against solar radiation and wind (U.S. Pat. No. 3,993,214A). There are also evaporation reduction methods using a polybutene and silicone based film, which hybridizes and forms cross-linking in the presence of oxygen on the water surface, and generates a film that resists degradation against wind, since it tends to self-repair in presence of physical damage (WO201420313101A1; U.S. Pat. No. 4,106,906A).

In addition, there are patents with respect to the use of Langmuir film in order to reduce the evaporation of water. There is a patent that uses a liquid mixture composed of an azeotropic mixture of isopropanol-water with 5% w/w of octadecanol and 10% w/w of butanol, to be easily applicable in small reservoirs at low temperatures. The mixture when applied generates the octadecanol film with the water, and the alcoholic mixture allows the mixture not to precipitate or agglomerate in freezing conditions (WO2004078341A1). On the other hand, there is a patent describing the use of a solution composed of polyoxyethylene molecules, dissolved in a solvent, plus other additives such as colorants, preservatives and fragrances. Polyoxyethylene is a long molecule described by the formula R—(OCH2CH2)nOH, where R corresponds to a long hydrophobic chain, in this case lauryl alcohol, and n is equal to 2. The mixture composition contains between 0.1-50% of this molecule, and its main use is its dispersion on an aqueous surface, where it generates a film thick enough to restrict evaporation and heat loss of water, being a non-toxic compound (US20070152190A1).

Finally, there is a patent describing the use of a powder having amphiphilic molecules associated with the surface of microparticles of ionic compounds, such as silicates or calcium hydroxide, which is applied on the surface of a body of water to form a water evaporation suppressing layer. As amphiphilic molecules, the use of stearyl and cetearyl alcohol is described, plus other examples (WO2006/012740A1).

From these patents, it can be concluded that there are various techniques used for the suppression of water evaporation, both physical and physicochemical, using the properties of the constructs and the molecules with amphiphilic nature used. In addition, the use of different mechanisms for utilizing a monolayer of a polymer or amphiphilic molecule to improve the suppression capacity of the ensemble or to decrease its degradation by attaching it to a surface is distinguished.

However, the methods mentioned above generally use materials that are considered toxic or environmentally unfriendly, being non-biodegradable, and may interfere with the various mechanisms that utilize large water reservoirs, such as in mining and agricultural lakes, which continually use water directly. In addition, the amount of materials and procedures needed to obtain a viable product, with respect to the products reviewed, are considerable compared to the amount needed to cover the surface of an average reservoir, and therefore are high cost solutions. Consequently, it is necessary to design a solution that is accessible, low cost, biodegradable, innocuous for use in industries and for the flora and fauna that have access to the reservoir. In addition, with an improved design of the amphiphilic molecules involved in the formation of the organic monolayer, it is possible to use other forces at the molecular level to improve the effectiveness of the evaporation suppressing effect and reduce its degradation due to environmental factors.

### REFERENCES

1.—McJannet, D., Cook, F., Knight J. and Burn, S. Evaporation reduction by monolayers: overview, modelling and effectiveness. CSIRO: Water for a Healthy Country National Research Flagship. Urban Water Security Research Alliance Technical Report No. 6. 2008.
2.—Department of Studies, Extension and Publications. Costo económico del use de agua desalada en la mineria chilena. 2017. Newsletter No 9185-08.
3.—U.S. Pat. No. 3,993,214 A. 1975. Georg Fischer AG.
4.—WO 2014203101 A1. 2014. Graham Strachan.
5.—U.S. Pat. No. 4,106,906 A. 1977. US Secretary of Navy.
6.—WO 2004078341 A1. 2003. Robert Neville O′brien.
7.—US 20070152190 A1. 2006. Edward Borish, Jonathan Dean. [8] WO 2006/012740 A1. 2006. O'brien Robert.

### DETAILED DESCRIPTION OF THE INVENTION

The present invention consists of an optimized composition to reduce water evaporation and to prevent and/or retard microalgae growth corresponding to an organic monolayer, comprising one or more amphiphilic hydrophobic chain molecules of 12 or more carbons, at a concentration of between 0.001-10 g/L, and a biodegradable organic volatile solvent, at a concentration of between 0.1-10 g/L.

Preferably, the amphiphilic hydrophobic chain molecules of 12 or more carbons, comprise at least one polar group of the alcohol, carboxylic, amine, amide, ether or ester type. Even more preferably, the amphiphilic hydrophobic chain molecules of 12 or more carbons, can be selected from fatty alcohols and/or fatty acids with long chains of hydrophobic hydrocarbons, such as hexadecanol, octadecanol, (poly)ethylene glycol mono-octadecyl ether, glycol stearate, stearyl citrate, among others.

The hydrophilic heads of the amphiphilic molecules interact directly with the water molecules through hydrogen bonds, coupling to the surface while the hydrophobic tails are grouped away from the surface and are compacted forming a compact hydrophobic barrier, generating what is known in the literature as a Langmuir-Blodgett film. This film has a suppressive or reducing effect on the evaporation of water on the surface of an aqueous body. In addition, this allows to generate a bilayer on the surface of the water, causing an anchoring site for amphiphilic molecules, which improves the stability, compactness and resistance to degradation of the monolayer, promoting a greater reduction of evaporation over time.

For its part, the biodegradable organic solvent is selected from among the type aromatics, chlorinated hydrocarbons, alcohols, ethers, esters, glycol derivatives, chlorofluorocarbons, miscellaneous. Preferably, the esters are selected from methyl acetate, ethyl acetate, butyl acetate, among others.

In an alternative modality, the present invention further comprises a polymer salt of natural origin, at a concentration between 0.01-100 mM, and an inorganic salt or bivalent salts, at a concentration of between 0.1-100 mM.

Preferably, the water-soluble natural polymer salt comprises at least one polar functional group of alcohol, carboxylic, amine, amide, ether or ester type, which interact through hydrogen bonds with the hydrophilic group of the amphiphilic molecules of the organic monolayer. Even more preferably, the water-soluble natural polymer salt may be selected from sodium alginate, sodium gum arabic, chitosan acetate, chitosan chloride, sodium carboxymethyl cellulose, among others of similar structures. Likewise, the inorganic salt or bivalent salt, is selected from sea salt, that comprises magnesium sulfate, calcium chloride, among others.

In this way, the bivalent cations are capable of making coordination complexes with certain amphiphilic molecules that have a polar group in the hydrophobic chain, such as ether, ester, amino, amide groups, among others, providing greater cohesion between the hydrophobic chains of the monolayer. The combination of the interaction forces between the organic monolayer with the water surface, the natural polymer salt and bivalent cations allow a great reduction of water evaporation and durability against climatic conditions of temperature, wind and solar radiation.

In a preferred modality, the present invention consists of a composition optimized to reduce water evaporation and to prevent and/or retard microalgae growth, wherein the amphiphilic hydrophobic chain molecules of 12 or more carbons, comprise a mixture of hexadecanol and octadecanol. Preferably, the present invention comprises a mixture of hexadecanol and octadecanol in a ratio of 1:1, dissolved in ethyl acetate, at a concentration of 1 g/L. The preferred mode of the invention has the advantage that the applied product is innocuous to be used on aquiferous accumulations.

According to the aforementioned, the present invention allows to reduce water evaporation by a percentage of between 70 and 80%, an effect that is maintained over time. As demonstrated in FIGS. 1 and 2, the present modality allows a higher percentage of evaporation reduction compared to other water evaporation suppressing compositions.

It should also be noted that the composition optimized to reduce water evaporation and to prevent and/or retard microalgae growth is eco-friendly, since it is not toxic to microorganisms and the environment, as shown in FIG. 3.

In addition, the present invention prevents and/or retards microalgae growth, as shown in FIGS. 4 and 5. This feature is advantageous in that microalgae produce a number of negative effects, such as the deterioration of membranes of agricultural and mining dams, as well as the clogging of drip irrigation systems or pipes, due to their contribution in the accumulation of mineral buildup. The aforementioned problems generate the need to incur in additional expenses related, for example, to the use of filters or other chemicals such as algaecides (which are undesirable because they are toxic both for the environment and for human consumption). In this way, the present invention allows the applied product to be accessible, of low cost for its development and use, in addition to being environmentally friendly as it is odorless, colorless and biodegradable.

Finally, the present invention comprises a method to reduce water evaporation and to prevent and/or retard microalgae growth, by applying the composition over aqueous surfaces of between 1 to 30 liters of the composition per hectare.

### FIGURES

FIG. 1 corresponds to a graph comparing the percentage of water remaining over time when applying different compositions, such as, Comp. 1: octadecanol dissolved in acetic acid, at a concentration of 1 g/L; Comp. 2: octadecanol and hexadecanol, at a concentration of 1 g/L, dissolved in acetic acid; Comp. 3: diethylene glycol monooctadecyl ether dissolved in acetic acid, at a concentration of 1 g/L; and the control: potable water. The graph represents the amount of water remaining after exposure to room temperature for a period of 31 days.

FIG. 2 corresponds to a graph where the variation of the total water height over time is measured in different vessels. The black rhombuses correspond to the control (vessel with potable water only). The white triangles correspond to the vessel with potable water and the composition Comp. 2.

FIG. 3 corresponds to a biotoxicity analysis of the composition Comp.2. The table summarizes the CFU/mL count of the three microbial cultures, namely Staphylococcus aureus, Escherichia coli DH5-α and Candida albicans, in the presence and absence of the Comp.2 composition, at a temperature of 37° C.

FIG. 4 corresponds to a graph where the change in water coloration in different vessels is measured. The black bars correspond to the control (vessel with potable water only). The white bars with dots correspond to the vessel with potable water and the Comp. 2 composition.

FIG. 5 corresponds to a graphical representation of the comparison of different vessels of 61 L each. A) corresponds to the control vessel (vessel with potable water only). B) corresponds to the vessel with potable water and the Comp. 2 composition.

### EXAMPLES

### Example No 1. Analysis of Different Compositions to Reduce Water Evaporation

In order to identify the best composition to reduce water evaporation, a comparative analysis was carried out between three different compositions, and the water evaporation reducing effect was measured. These compositions were: Comp.1 (octadecanol dissolved in acetic acid, at a concentration of 1 g/L), Comp. 2 (octadecanol and hexadecanol, at a concentration of 1 g/L, dissolved in acetic acid), Comp. 3 (diethylene glycol mono-octadecyl ether dissolved in acetic acid, at a concentration of 1 g/L), and the control (vessel with only potable water).

Each composition was analyzed in quadruplicate to determine the effectiveness in preventing water evaporation over a period of 31 days. Measurements of the remaining water in each vessel were taken every 2 to 3 days.

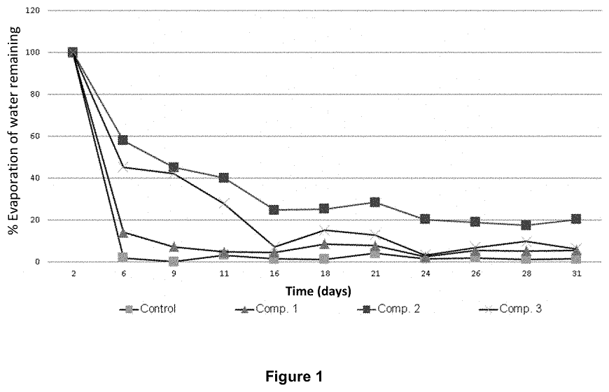

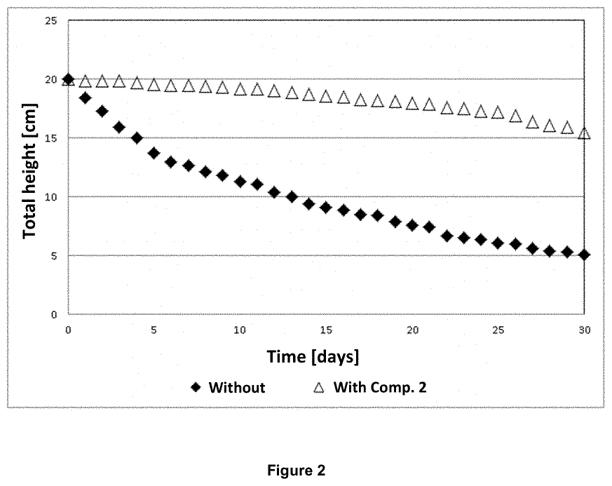

From the measurements performed, it can be observed that when comparing the control (water only) with the different compositions analyzed, the Comp. 2 composition prevents a greater evaporation of water, reaching between 70 and 80% reduction of water evaporation, as shown in FIGS. 1 and 2.

Likewise, it can be observed that the Comp.2 composition allows reducing water evaporation for a longer period of time than other compositions analyzed. This may be due to the fact that the Comp.2 composition has a combination of hydrophobic chains that are highly compact, which provides greater rigidity and separation between the hydrophobic and polar regions. For this reason, the inventors chose the Comp.2 composition as the one that allows to reduce the percentage of water evaporation in the highest amount.

### Example No 2. Analysis of the Effect of Comp.2 Composition to Reduce Water Evaporation

In order to determine the effectiveness of the Comp.2 composition in reducing water evaporation, measurements of water height variation in different vessels were carried out.

For this purpose, two different plastic vessels of 61 L each were used, which were filled with potable water to a height of 20 cm. Subsequently, the Comp.2 composition was added to the surface of the water in one of the vessels. The control vessel corresponds to the vessel with potable water without the Comp.2 composition.

To measure the effect of the Comp. 2 composition in reducing water evaporation, a period of time of 1 month was allowed to elapse under the same environmental conditions (sun, temperature, wind, etc.).

In addition, measurements were done to the temperature range that fluctuates during the course of the day and night. Maximum temperatures fluctuated between 33° C. and 18° C., and minimum temperatures fluctuated between 13° C. and 4° C.

As can be seen in FIG. 2, the vessel containing the Comp. 2 composition on its surface, only showed 25% evaporation of water, compared to the vessel not containing the Comp. 2 composition on the surface, where 75% evaporation was detected.

Thus, it can be seen that the Comp. 2 composition generates a surprising effect, since it considerably reduces water evaporation.

### Example No 3. Safety Analysis of the Comp. 2 Composition

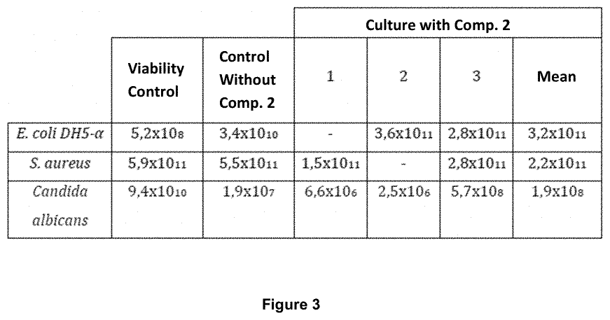

In order to determine whether the Comp. 2 composition is toxic or not, a biotoxicity analysis of this composition was carried out. For this purpose, the growth of different microorganisms such as Staphylococcus aureus, Escherichia coli DH5-α and Candida albicans was analyzed in different cultivation media in the presence and absence of the Comp. 2 composition, at a temperature of 37° C., as shown in FIG. 3.

Subsequently, aliquots of the different cultivation media were taken for serial dilutions, which were then seeded on LB agar and PDA agar plates, at a temperature of 37° C.

According to the results obtained, the three cultivations of Staphylococcus aureus, Escherichia coli DH5-α and Candida albicans, were viable both in the presence and absence of the Comp. 2 composition, at a temperature of 37° C.

Thus, it can be concluded that the Comp. 2 composition is not toxic to any of the three microorganisms.

### Example No 4. Effect of Comp.2 Composition to Prevent and/or Retard the Microalgae Growth

In order to determine the effect of the Comp. 2 composition in preventing and/or retarding the microalgae growth, the coloration of the water in different vessels was measured.

For this purpose, two plastic vessels of 61 L each were used, which were filled with potable water to a height of 20 cm. Subsequently, the Comp. 2 composition was added to the surface of the water in one of the vessels. The control vessel corresponds to the vessel with potable water without the Comp. 2 composition.

To measure water coloration, a period of 1 month was allowed to elapse under the same environmental conditions (sun, heat, wind, etc.), taking samples every 7 days, which were measured qualitatively and quantitatively.

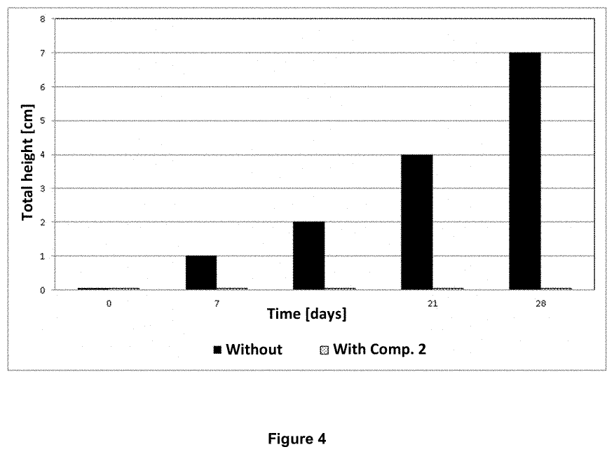

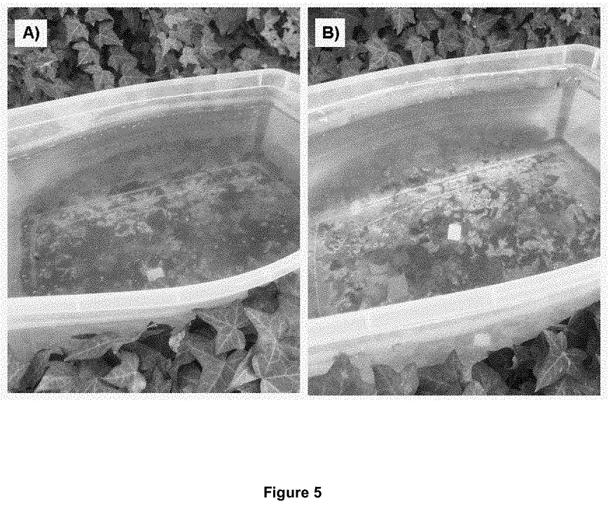

As can be seen in FIGS. 4 and 5, surprisingly, the Comp. 2 composition prevents and/or retards the microalgae growth. Thus, the use of the Comp. 2 composition avoids incurring additional expenses, such as the use of filters or other chemical agents such as algaecides, which are toxic both for the environment and for human consumption.

1. A composition optimized to reduce water evaporation and to prevent and/or retard microalgae growth CHARACTERIZED in that it comprises:
a) one or more amphiphilic molecules with a hydrophobic chain of 12 or more carbons, at a concentration between 0.001-10 g/L, and
b) a biodegradable organic volatile solvent, at a concentration of between 0.1-10 g/L.

2. The composition according to claim 1, CHARACTERIZED in that the amphiphilic hydrophobic chain molecules of 12 or more carbons comprise at least one polar group of the alcohol, carboxylic, amine, amide, ether or ester type.

3. The composition according to claim 1, CHARACTERIZED in that the amphiphilic hydrophobic chain molecules of 12 or more carbons are selected from fatty alcohols and/or fatty acids with long chains of hydrophobic hydrocarbons, such as hexadecanol, octadecanol, (poly)ethylene glycol mono-octadecyl ether, glycol stearate, stearyl citrate, among others.

4. The composition according to claim 1, CHARACTERIZED the biodegradable organic solvent is selected from among the type aromatics, chlorinated hydrocarbons, alcohols, ethers, esters, glycol derivatives, chlorofluorocarbons, miscellaneous.

5. The composition according to claim 4, CHARACTERIZED in that the esters are selected from methyl acetate, ethyl acetate, butyl acetate, among others.

6. The composition according to claim 1, CHARACTERIZED in that it further comprises:
a) a polymer salt of natural origin, at a concentration of between 0.01-100 mM; and.
b) an inorganic salt or bivalent salts, at a concentration of between 0.1-100 mM.

7. The composition according to claim 6, CHARACTERIZED in that the water-soluble polymer salt of natural origin comprises at least one polar functional group of alcohol, carboxylic, amine, amide, ether or ester type, which interact with the polar group of the amphiphilic molecule.

8. The composition according to claim 6, CHARACTERIZED in that the water-soluble polymer salt of natural origin is selected from sodium alginate, sodium gum arabic, chitosan acetate, chitosan chloride, sodium carboxymethyl cellulose, among others of similar structures.

9. The composition according to claim 6, CHARACTERIZED in that the inorganic salt or bivalent salt is selected from sea salt, comprising magnesium sulfate, calcium chloride, among others.

10. The composition according to claim 1, CHARACTERIZED in that the amphiphilic hydrophobic chain molecules of 12 or more carbons comprise a mixture of hexadecanol and octadecanol.

11. The composition according to claim 10, CHARACTERIZED in that it comprises a mixture of hexadecanol and octadecanol in a ratio of 1:1, dissolved in ethyl acetate, at a concentration of 1 g/L.

12. A method to reduce water evaporation and to prevent and/or retard microalgae growth, according to all of the preceding claims, CHARACTERIZED in that the composition is applied on aqueous surfaces, between 1 to 30 liters of the composition per hectare.
